(19) United States
(12) Patent Application Publication
(10) Pub. No.: US 2002/0154508 A1
(43) Pub. Date: Oct. 24, 2002

(54) DIY ASSEMBLY LAMP STRUCTURE

(76) Inventor: Wen-Chang Wu, Chang Hua Hsien (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/838,295

(22) Filed: Apr. 20, 2001

(51) Int. Cl. F21S 8/08

(52) U.S. Cl. 362/413; 362/410; 362/414

(57) ABSTRACT

A DIY assembly lamp structure comprised of a two-section lamp pipe consisting of an upper and lower pipe body, an upper and lower positioning block fitted onto the upper and lower pipe body, respectively, and four support members that are appropriately contoured by bending and, furthermore, with each having an vertical affixing portion that is fastened to the sides of the positioning blocks. The upper pipe body of the lamp pipe has a brackets disposed vertically and extending upward from its top end, a carrier hole is formed in each bracket and, furthermore, tightly fitted into the bracket carrier holes is an annular-shaped brace rod capable of supporting the lamp shade, the annular-shaped brace rod providing for the placement and positioning of the center ring of the lamp shade. A fronting portion having a fastening hole is formed vertically and downward from each of the lateral edges of the cross-shaped positioning blocks, thereby providing for the alignment and fastening of the vertically disposed, frame member affixing portions to the positioning block fronting portions. As such, since the lamp components are stackable, this minimizes the physical space needed for assembly, reduces storage and shipping dimensions and, furthermore, facilitates user convenience in DIY lamp assembly, while effectively allowing disassembly for replacement and cleaning.

### BACKGROUND OF THE INVENTION

1) Field of the Invention

The invention herein relates to a DIY assembly lamp structure in which an upper pipe body has carrier holes disposed vertically and extending upward from its top end, and, furthermore, tightly fitted into the carrier holes is an annular-shaped brace rod capable of supporting a lamp shade; a fronting portion having a fastening hole is formed vertically and downward from each of the lateral edges of a cross-shaped positioning block, the structural features providing for the alignment and fastening of vertically disposed, frame member affixing portions to the positioning block fronting portions, thereby enabling a minimizing of the physical space needed for assembly, a reduction in storage and shipping dimensions and, furthermore, facilitates user convenience in DIY lamp assembly, while effectively allowing disassembly for replacement and cleaning.

2) Description of the Prior Art

In most conventional lamp structures, the lamp shade is screw-fastened with nuts and bolts to the lamp pipe of the lamp base; however, with this fastening method, since the lamp pipe of the lamp is a lengthy rod-like structure and, furthermore, the lower base of the lamp has a diameter that is somewhat larger than the lamp shade mounting structure, when package in cartons, the lower base of the lamp and the lamp pipe occupies substantial space and results in articles requiring excessive room during boxing, and since storage and shipping dimensions cannot be reduced, there is a commensurate increase in product shipping cost, furthermore, user DIY assembly and storage requires more area.

In addition, since the lamp shade is assembled to the top end of the lamp pipe, the lamp shade does not meet user requirements for pattern and color changes and, furthermore, the lamp shade cannot be removed for cleaning, this results in user inconvenience; in view of the said shortcomings, the inventor of the invention herein conducted research which culminated in the successful development of the invention herein.

### SUMMARY OF THE INVENTION

The primary objective of the invention herein is to provide a DIY assembly lamp structure in which an upper pipe body has carrier holes disposed vertically and extending upward from its top end, and, furthermore, tightly fitted into the carrier holes is an annular-shaped brace rod capable of supporting a lamp shade, the annular-shaped brace rod providing for the placement and positioning of the center ring of the lamp shade; a fronting portion having a fastening hole is formed vertically and downward from each of the lateral edges of a cross-shaped positioning block, providing for the alignment and fastening of vertically disposed, frame member affixing portions to the positioning block fronting portions; as such, this minimizes the physical space needed for assembly, reduces storage and shipping dimensions and, furthermore, facilitates user convenience in DIY lamp assembly, while effectively allowing disassembly for replacement and cleaning.

### BRIEF DESCRIPTION OF THE DRAWINGS

FIG. 1 is an exploded drawing of the invention herein.

FIG. 2 is an isometric drawing of the invention herein.

FIG. 3 is an isometric drawing of the invention herein.

FIG. 4 is a cross-sectional drawing of another embodiment of the invention herein.

### DETAILED DESCRIPTION OF THE INVENTION

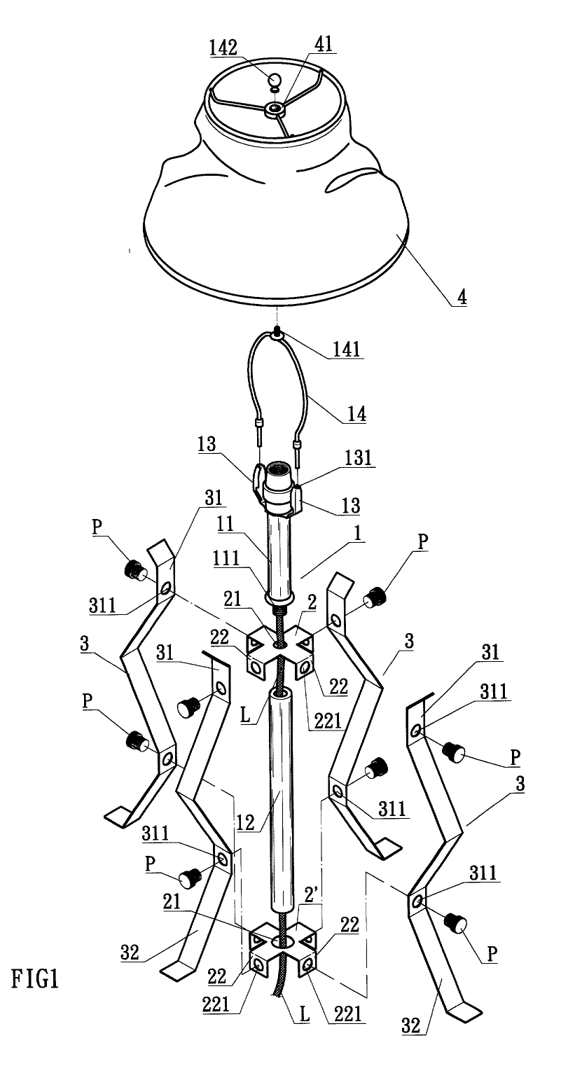

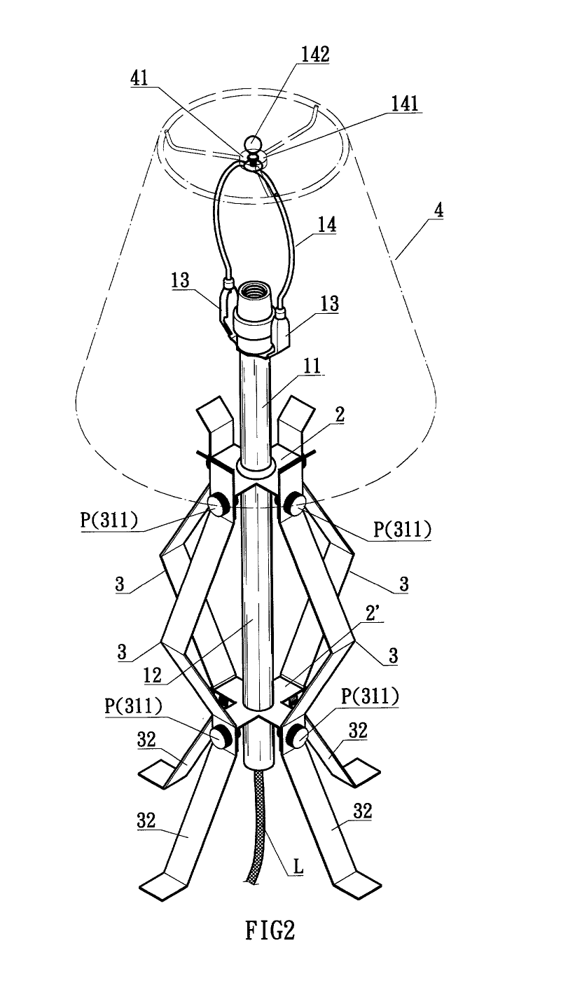

Referring to FIG. 1 and FIG. 2, the structural arrangement of the present invention, the invention herein is comprised of a table lamp fixed and erected on a lamp base A structure and a lamp shade 4 structure situated at the top end of the lamp base A that, furthermore, has a degree of folding flexibility and is capable of enhancing aesthetic appearance.

The lamp base A is comprised of a power line L inserted through the interior section and, furthermore, a two-section lamp pipe 1 consisting of an upper and lower pipe body 11 and 12 as well as an upper and lower positioning block 2 and 2′ fitted onto the upper and lower pipe body 11 and 12, respectively, and four support members 3 that are appropriately contoured by bending and, furthermore, with each having an affixing portion 31 that is fastened to the side of the positioning block 2, wherein:

The upper pipe body 11 of said lamp pipe 1 has a threaded section 111 projecting from its bottom end that provides for fastening to the lower pipe body 12; furthermore, the upper pipe body 11 has a bracket 13 disposed vertically and facing upward at each of the two sides of its top end, and a carrier hole 131 is formed in each vertically extending section of the bracket 13; tightly fitted into the bracket 13 carrier holes 131 is an annular-shaped brace rod 14 capable of supporting the lamp shade 4; the said brace rod 14 has threaded stud 141 projecting from its top end that provides for placing a center ring 41 at the upper extent of the lamp shade 4 over the threaded stud 141, and a knob 142 is fastened onto the threaded stud 141 to position the lamp shade 4 at the upper extent of the annular-shaped brace rod 14.

The said upper positioning block 2 is assembled between the upper and lower pipe body 11 and 12 of the lamp pipe 1, while the lower positioning block 2′ is assembled to the bottom end of the lower pipe body 12, the said positioning block 2 has a coupling hole 21 at its center and, furthermore, a fronting portion 22 is formed vertically and downward from each of the lateral edges of the positioning block 2 cross and, furthermore, there is a fastening hole 221 in each fronting portion 22.

The said support members 3 are flat structures bent into an appropriate contour, with each support member 3 having a vertical affixing portion 31 formed at the curvature against the lamp pipe 1 and, furthermore, there is a fastening hole 311 in each, affixing portion 31 and the length separating every two affixing portions 31 matches the distance between the upper and lower positioning blocks 2 and 2′, thereby providing for the alignment and fastening of the frame member 3 affixing portions 31 to the positioning block 2 and 2′ fronting portions 22; and the bottom ends of the frame members 3 are bent outward into a curve to form feet 32 that serve as the lamp base A stabilized by the frame members 3.

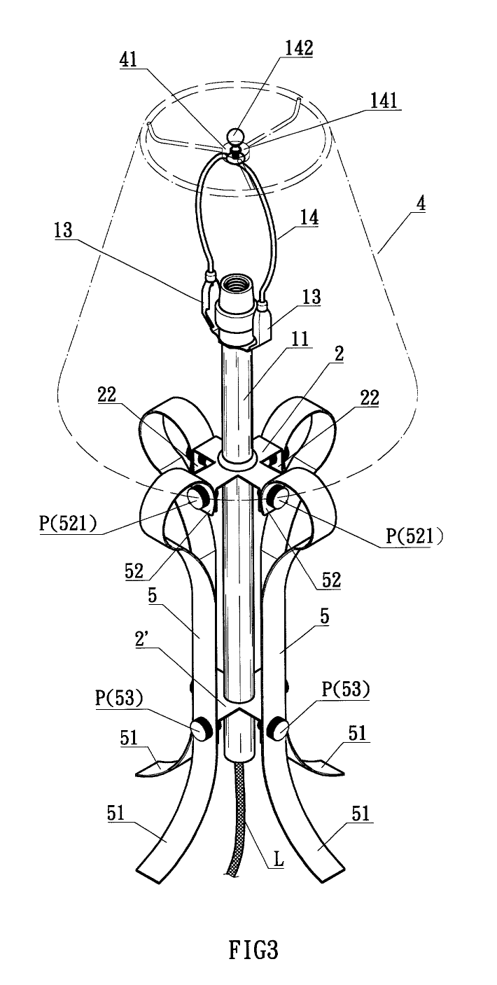

The method of assembly, as indicated in FIG. 3, consists of first ensleeving the upper positioning block 2 onto the lamp pipe 1 threaded section 111 at the bottom end of the upper pipe body 11 and then fastening the lower pipe body 12 to the bottom end of the upper pipe body 11 to thereby secure the upper positioning block 2 between the upper and lower pipe bodies 11 and 12; since there is a fastening hole 221 in each of the vertically disposed fronting portions 22 of the upper and lower positioning blocks 2 and 2′ and, furthermore, the fastening holes 311 in each of the vertically disposed affixing portions 31 of the support members 3 are aligned with them, this provides for the sequential insertion of a bolt P into all of the fastening member 3 and positioning block 2 fastening holes 311 and 211 to complete the assembly of the lamp base A structure; the annular-shaped brace rod 14 is snugly fitted into the carrier holes 131 formed at the two sides of the upper pipe body 11 and, furthermore, the center ring 41 of the lamp shade 4 is placed onto the threaded stud 141 at the top end of the annular-shaped brace rod 14 and the knob 142 is fastened onto the threaded stud 141 to position the lamp shade 4 at the upper extent of the annular-shaped brace rod 14, thereby completing the lamp structure.

The disassembly arrangement of the invention herein is as follows: the said frame members 3 are stacked following removal and, furthermore, the upper and lower pipe bodies 11 and 12 of the lamp pipe 1, the positioning blocks 2 and 2′, and the annular-shaped brace rod 14 situated at the top end of the upper pipe body 111 are respectively removed and arranged; as such, when packaged in cartons, this minimizes the physical space needed for assembly, reduces storage and shipping dimensions and, furthermore, facilitates user convenience in DIY lamp assembly, while effectively allowing disassembly for replacement and cleaning.

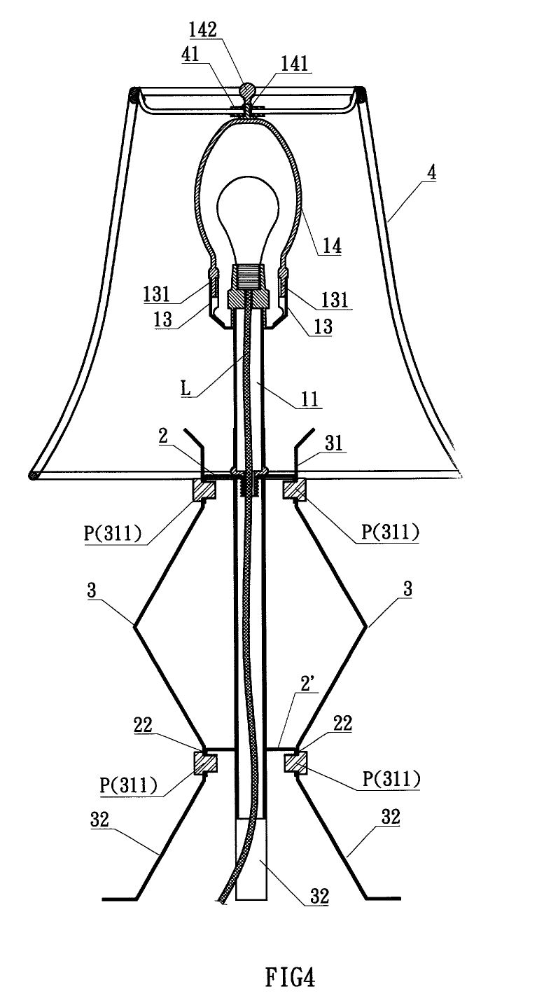

Referring to FIG. 4, the drawing of another embodiment of the invention herein, the bottom ends of the said frame members 5 are curved slightly outward to form feet 51 that function as the lamp base A stabilized by the frame members 5; the top ends of the frame members 5 are bent inward into a circular shape and conjoinment portions 52 are vertically disposed at the ends and, furthermore, there is a fastening hole 521 in each of the conjoinment portions 52, and there is a fastening hole 53 is each of the support members 5 at the position where they meet the lower positioning block 2′ to provide for the alignment and securing of the frame member 5 fastening holes 521 and 53 to the fronting portions 22 of the positioning blocks 2 and 2′.

1. A DIY assembly lamp structure comprised of a lamp base structure and a lamp shade structure situated at the top end of the said lamp base.
The said lamp base is comprised of a power line inserted through the interior section and, furthermore, a two-section lamp pipe consisting of a screw-fastened upper and lower pipe body as well as an upper and lower positioning block fitted onto the said upper and lower pipe body, respectively, and four support members that are appropriately contoured by bending.
The said upper pipe body of the said lamp pipe has a brackets disposed vertically and facing upward at its top end, and a carrier hole is formed in each said bracket; tightly fitted into the said bracket carrier holes is an annular-shaped brace rod capable of supporting the said lamp shade; the said brace rod has a threaded stud projecting from its top end that provides for placing the center ring at the upper extent of the said lamp shade over the said threaded stud, and a knob is fastened onto the said threaded stud.
The said upper positioning block is respectfully assembled between the said upper and lower pipe body of the said lamp pipe, while the said lower positioning block is assembled to the bottom end of the said lower pipe body; the said positioning block has a coupling hole at its center and, furthermore, a fronting portion having a fastening hole is formed vertically and downward from each of the lateral edges of the cross of the said positioning block.
The said support members are flat structures bent into an appropriate contour, with each said support member having vertical affixing portions formed at the curve against the said lamp pipe and, furthermore, there is a fastening hole in each said affixing portion, thereby providing for the alignment and fastening of the said frame member affixing portions to the said upper and lower positioning block fronting portions; and the bottom ends of the said frame members are bent outward into a curve to form feet that serve as the said lamp base stabilized by the said frame members.
As such, this minimizes the physical space needed for assembly, reduces storage and shipping dimensions and, furthermore, facilitates user convenience in DIY lamp assembly, while effectively allowing disassembly for replacement and cleaning.

2. As mentioned in claim 1 of the DIY assembly lamp structure of the invention herein, the bottom ends of the said frame members are curved slightly outward to form the said feet; the top ends of the said frame members are bent inward into a circular shape and conjoinment portions are vertically disposed at the ends and, furthermore, there is a fastening hole in each of the said conjoinment portions, and there is a fastening hole is each of the said support members at the position where they meet the said lower positioning block to provide for the alignment and securing of the said frame member fastening holes to the said fronting portions of the said positioning blocks.
